(19) United States
(12) Patent Application Publication
(10) Pub. No.: US 2004/0088724 A1
(43) Pub. Date: May 6, 2004

(54) Apparatus and method for controlling picture ratio and remote control device thereof

(75) Inventors: Sung-bae Hwang, Seoul (KR); Young-han Kim, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-city (KR)

(21) Appl. No.: 10/687,605

(22) Filed: Oct. 20, 2003

(30) Foreign Application Priority Data
Oct. 30, 2002 (KR) 2002-66578

(51) Int. Cl. G06F 13/00

(52) U.S. Cl. 725/37

(57) ABSTRACT

A picture ratio controlling apparatus and method by which a user controls a picture ratio of a video signal provided to a video display device so as to easily control the picture ratio of the video signal displayed on the video display device. The picture ratio controlling apparatus includes a video display device displaying a video, and a system controller determining at least one selectable picture ratio mode based on information of the picture ratio of a source video to be provided to the video display device and the information of the picture ratio that can be supported by the video display device, and controls the picture ratio of the source video provided to the video display device, when a user requests a picture ratio selection. Accordingly, the user can control the picture ratio of a video displayed on the video display device by simply manipulating a key.

### CROSS-REFERENCE TO RELATED APPLICATIONS

This application claims the priority of Korean Patent Application No. 2002-66578, filed on Oct. 30, 2002, in the Korean Intellectual Property Office, the disclosure of which is incorporated herein in its entirety by reference.

### BACKGROUND OF THE INVENTION

1. Field of the Invention

The present invention relates to an apparatus and method to control a picture ratio and a remote control device thereof, and more particularly, to a picture ratio controlling apparatus and method by which a user can easily control a ratio of a picture displayed on a video display device, and a remote control device thereof.

2. Description of the Related Art

Representative video display devices are televisions. Currently proposed televisions include devices that display a video in a picture ratio of 16:9, in a picture ratio of 4:3, and selectively in picture ratios of 16:9 and 4:3. The picture ratio denotes an aspect ratio of a picture.

However, although a video signal displayed on the video display device can be classified as the video signal having a picture ratio of 16:9 and an image signal having the picture ratio of 4:3, its source video signal may not have the picture ratio of 16:9 or 4:3. In other words, even though the displayed video signal is classified as the video signal having the picture ratio of 16:9, a corresponding source video signal may have the picture ratio of 16:9 or 2.35:1. The presence of the video signal having the picture ratio of 2.35:1 is caused by a size of a film used in producing the video signal. For a similar reason, although the displayed video signal is classified as the video signal having the picture ratio of 4:3, the corresponding source video signal may have the picture ratio of 4:3 or 1.85:1. The source video signal may have various picture ratios besides the picture ratio of 2.35:1 or 1.85:1.

The above-described examples of the picture ratio can be seen in a hybrid system in which a digital versatile disc (DVD) player is combined with the television. In other words, in a case of a DVD onto which the video signal having the picture ratio of 16:9 is to be recorded, an actually recorded video signal may have the picture ratio of 16:9 or 2.35:1. In a case of the DVD onto which the video signal having the picture ratio of 4:3 is to be recorded, the actually recorded video signal may have the picture ratio of 4:3 or 1.85:1.

In an event that the source video signal has the picture ratio of 2.35:1 or 1.85:1, the video signal on the video display device contains black bars in upper and lower portions thereof so as to be fit for the picture ratio of 16:9 or 4:3 when displayed on the video display device. The video signal recorded on the DVD with the picture ratio of 2.35:1 or 1.85:1 includes the black bars in the upper and lower portions thereof.

Viewers may feel impatient of such black bars in the upper and lower portions of the video signal. However, the hybrid system serves to provide the video display device with the video signal fit for the picture ratio of 16:9 or 4:3 onto which black bars are inserted. Thus, it is difficult for the viewers to control the picture ratio displayed on the video display device.

### SUMMARY OF THE INVENTION

The present invention provides a picture ratio controlling apparatus and method by which a user can control a picture ratio of a video signal provided to a video display device, such as a television, so as to easily control the picture ratio of the video signal actually displayed on the video display device, and a remote control device thereof.

The present invention also provides a picture ratio controlling apparatus and method by which a picture ratio of a video signal provided to a video display device can be controlled according to a picture ratio mode selected by a user among a plurality of picture ratio modes and determined in consideration of the picture ratio of a source video where the picture ratio can be supported by the video display device, and a remote control device thereof.

The present invention also provides a picture ratio controlling apparatus and method by which a picture ratio of a video signal provided from a disc drive to a video display device in a hybrid system, in which the disc drive is connected to the video display device, and can be controlled according to a picture ratio mode selected by a user so as to control the picture ratio displayed on the video display device, and a remote control device.

Additional aspects and/or advantages of the invention will be set forth in part in the description which follows and, in part, will be obvious from the description, or may be learned by practice of the invention.

According to an aspect of the present invention, there is provided a picture ratio controlling apparatus including a video display device and a system controller. The video display device displays a video. The system controller determines a selectable picture ratio mode based on information of a picture ratio of a source video provided to the video display device and information of the picture ratio that can be supported by the video display device and controls the picture ratio of the source video provided to the video display device when a user requests a picture ratio selection.

The picture ratio controlling apparatus further includes a remote control receiver that receives the request for the picture ratio selection. The remote control receiver further receives a signal to select the picture ratio information that is supported by the video display device.

If a plurality of selectable picture ratio modes are determined, the system controller determines an order to select the plurality of selectable picture ratio modes, and selects one picture ratio mode when the picture ratio selection is requested to control the picture ratio of the source video.

The picture ratio controlling apparatus further includes a memory that classifies information of the selectable picture ratio modes, which can be determined based on the picture ratio information of the source video and the picture ratio information that can be supported by the video display device, into n×m groups. The memory stores the n×m groups if the information of available picture ratios of the source video are n and information of picture ratios that can be supported by the video display device are m. The system controller determines the picture ratio modes with reference to the information group of the selectable picture ratio modes read from the memory based on the picture ratio information of the source video and the picture ratio information that can be supported by the video display device.

According to another aspect of the present invention, there is provided a remote control device to control a picture ratio of a video displayed on a video display device. The remote control device includes a button unit including a picture ratio selection button used to select the picture ratio of a video, a memory that stores code information corresponding to functions that are controlled using buttons included in the button unit, a controller that reads a corresponding code from the memory when the picture ratio selection button is enabled and transmits the code to the video display device, and a transmitter that transmits the code to the video display device.

According to still another aspect of the present invention, there is provided a remote control device to control a picture ratio of a video displayed on a video display device in a hybrid system including a video signal proving unit to provide a source video and the video display device to display a video signal. The remote control device includes a button unit including buttons and a picture ratio selection button to select the picture ratio of the source video output from the video signal providing unit, a memory storing code information corresponding to functions that are controlled using the buttons in the button unit, a controller reading a corresponding code from the memory when the picture ratio selection button is controlled and transmitting the code to the video signal providing unit, and a transmitter transmitting the code to the video signal providing unit.

According to yet another aspect of the present invention, there is provided a picture ratio controlling apparatus used in a system including a disc drive and a video display device. The picture ratio controlling apparatus includes a digital signal processor that converts a video signal picked up from a disc loaded in the disc drive into a digital signal, a decoder that decodes the digital signal output from the digital signal processor to provide the decoded video signal to the video display device, and a system controller that determines a selectable picture ratio mode based on picture ratio information of the decoded video signal and the picture ratio information that is supported by the video display device and controls the decoder so that a picture ratio of the video signal output from the disc driver is controlled by a picture ratio mode selected when a user requests a picture ratio selection.

If a plurality of selectable picture ratio modes are determined, the system controller determines an order to select the plurality of selectable picture ratio modes, and selects one picture ratio mode when the picture ratio selection is requested to control the picture ratio of the video signal output from the disc drive.

According to yet another aspect of the present invention, there is provided a method of controlling a ratio of a picture displayed on a video display device. The method includes: collecting picture ratio information of a video signal provided to the video display device and the picture ratio information that is supported by the video display device; determining a selectable picture ratio mode based on the picture ratio information of the video signal and the picture ratio information that is supported by the video display device; and controlling the ratio of the picture displayed on the video display device by controlling the picture ratio of the video signal to be fit for the picture ratio mode selected among the determined picture ratio modes when a user requests a picture ratio selection.

The selectable picture ratio mode is determined by detecting a corresponding picture ratio mode group among a plurality of picture ratio mode groups pre-set in consideration of a number of picture ratio information of the video signal and the number of picture ratio information that is supported by the video display device.

The picture ratio information of the video signal is collected using a result obtained by analyzing management information included in the video signal, and the picture ratio information that can be supported by the video display device is collected using information pre-set by the user.

According to yet another aspect of the present invention, there is provided a picture ratio controlling method used in a system including a disc drive and a video display device to display a video signal provided from the disc drive. The picture ratio controlling method includes: collecting picture ratio information of a video signal reproduced from a disc loaded into the disc drive and the picture ratio information that is supported by the video display device; determining a selectable picture ratio mode based on the picture ratio information of the video signal reproduced from the disc and the picture ratio information that is supported by the video display device; and controlling a ratio of a picture displayed on the video display device by controlling a picture ratio of the video signal reproduced from the disc to be fit for the picture ratio mode selected among the determined picture ratio modes when a user requests a picture ratio selection.

### BRIEF DESCRIPTION OF THE DRAWINGS

These and/or other aspects and advantages of the invention will become apparent and more readily appreciated from the following description of the embodiments taken in conjunction with the accompanying drawings in which:

FIG. 1 is a block diagram of a hybrid system including a picture ratio controlling apparatus, according to an aspect of the present invention;

FIG. 2 is a detailed block diagram of a remote control device shown in FIG. 1;

FIGS. 3A and 3B illustrate selectable picture ratio modes when a picture ratio of a video signal recorded on a disc is 16:9 and the picture ratio set by a video display device is 4:3;

FIGS. 4A and 4B illustrate the selectable picture ratio modes when the picture ratio of the video signal recorded on the disc is 16:9 and the picture ratio set by the video display device is 16:9;

FIGS. 5A and 5B illustrate the selectable picture ratio modes when the picture ratio of the video signal recorded on the disc is 16:9 and the picture ratio set by the video display device is 4:3;

FIGS. 6A and 6B illustrate the selectable picture ratio modes when the picture ratio of a video signal recorded on the disc is 4:3 and the picture ratio set by the video display device is 16:9; and

FIG. 7 is a flowchart of the picture ratio controlling method, according to an aspect of the present invention.

### DETAILED DESCRIPTION OF THE PREFERRED EMBODIMENTS

Reference will now be made in detail to the aspects of the present invention, examples of which are illustrated in the accompanying drawings, wherein like reference numerals refer to the like elements throughout. The aspects are described below to explain the present invention by referring to the figures.

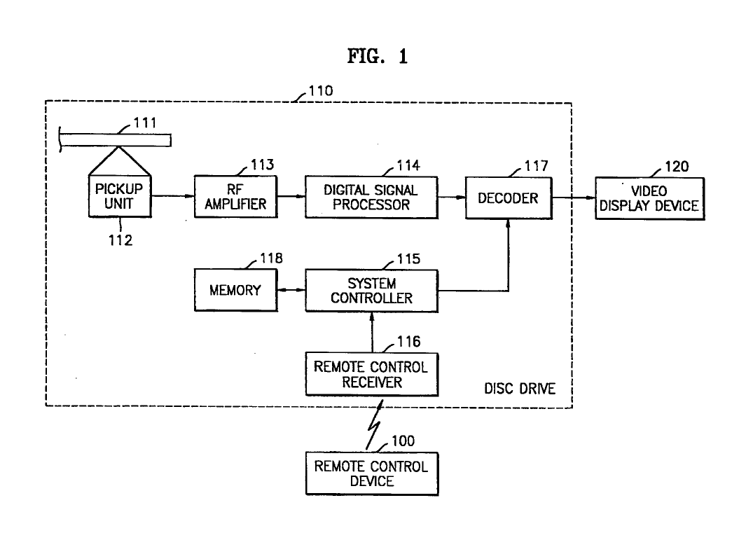

FIG. 1 is a block diagram of a hybrid system including a picture ratio controlling apparatus, according to an aspect of the present invention. Referring to FIG. 1, the hybrid system includes a remote control device 100, a disc drive 110, and a video display device 120.

The remote control device 100 controls an operation of the disc drive 110. According to an aspect of the present invention, the remote control device 100 may select a picture ratio selection command and picture ratio information that can be supported by the video display device 120. The picture ratio information may be set using a setup menu. For this, the remote control device 100 may include a setup button, an enter button, and direction buttons.

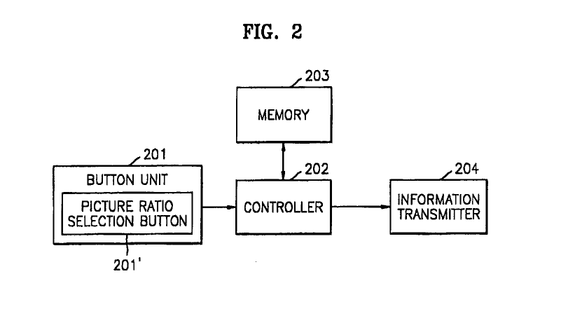

As shown in FIG. 2, the remote control device 100 includes a button unit 201, a controller 202, a memory 203, and an information transmitter 204.

The button unit 201 includes a picture ratio selection button 201′. The button unit 201 also includes functional buttons (not shown) that control all operations of the disc drive 110.

The controller 202 reads a code from the memory 203 according to a signal transmitted from the button unit 201. The code is information that can be recognized by a system controller 115 of the disc drive 110. The controller 202 transmits the code read from the memory 203 to the information transmitter 204 and the information transmitter 204 transmits the code to the disc drive 110. Accordingly, when the picture ratio selection button 201′ is controlled, the controller 202 reads a corresponding code from the memory 203 and transmits the corresponding code to the information transmitter 204. The information transmitter 204 transmits the corresponding code to the disc drive 110.

As shown in FIG. 1, the disc drive 110 includes a disc 111, a pickup unit 112, a radio frequency (RF) amplifier 113, a digital signal processor 114, a system controller 115, a remote control receiver 116, a decoder 117, and a memory 118.

A video signal is recorded on the disc 111. The pickup unit 112 picks up the video signal recorded on the disc 111 and outputs the video signal as an RF signal. The RF signal contains management information, such as the picture ratio information of the disc 111 and the like. The RF amplifier 113 amplifies the RF signal output from the pickup unit 112 to a predetermined value and outputs the amplified RF signal. The digital signal processor 114 converts the amplified RF signal into a digital signal and transmits the digital signal to the decoder 117.

The system controller 115 determines a plurality of selectable picture ratio modes based on the picture ratio information of the reproduced video signal provided from the decoder 117 and the picture ratio information that may be supported by the video display device 120. The picture ratio information that may be supported by the video display device 120 is set according to a TV mode selected by a user from the setup menu of the disc drive 110. The system controller 115 can determine the plurality of selectable picture ratio modes with reference to a group of information pieces of picture ratio modes pre-stored in the memory 118.

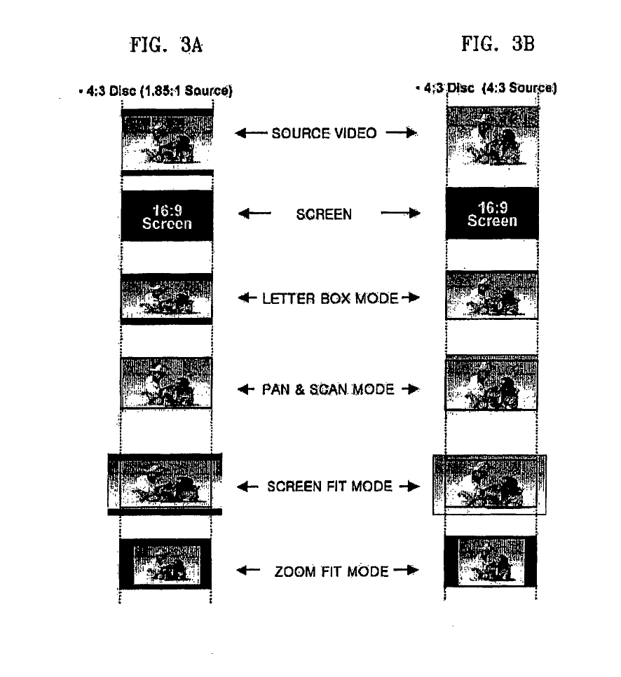

For example, when a picture ratio of the video signal reproduced from the disc 111 is 16:9 and the picture ratio that may be supported by the video display device 120 is 4:3, as shown in FIGS. 3A and 3B, the picture ratio modes may be determined so as to be selected in an order of a letter box mode, a pan & scan mode, a screen fit mode, and a zoom fit mode. The letter box mode, the pan & scan mode, the screen fit mode, and the zoom fit mode use existing video signal processing methods. The screen fit mode controls a picture ratio according to a line interpolation method so that a displayed picture stretches up and down. The zoom fit mode adjusts right and left portions and upper and lower portions of the displayed picture so that the picture ratio of the displayed picture is fit for the picture ratio supported by the video display device 120.

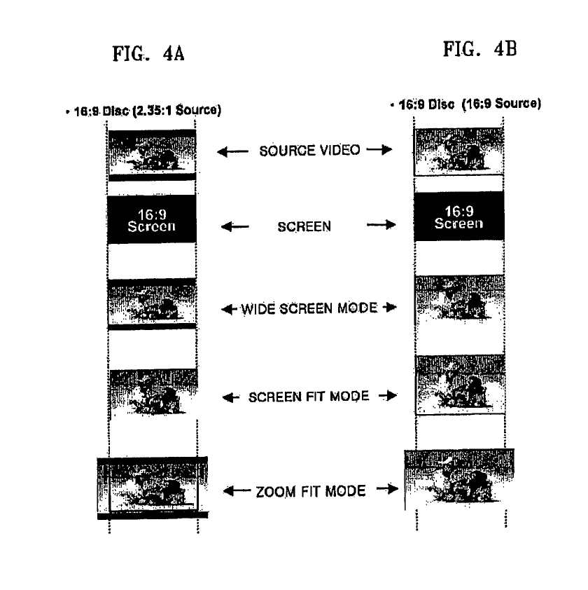

In a case where the video signal recorded on the disc 111 has the picture ratio of 16:9 and the picture ratio set by the video display device 120 is 16:9, as shown in FIGS. 4A and 4B, the picture ratio modes may be determined so as to be selected in an order of a wide screen mode, the screen fit mode, and the zoom fit mode.

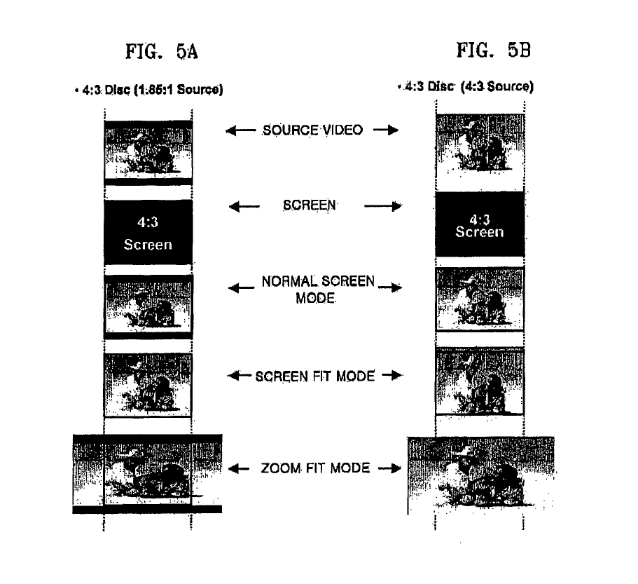

In an event that the video signal recorded on the disc 111 has the picture ratio of 16:9 and the picture ratio set by the video display device 120 is 4:3, as shown in FIGS. 5A and 5B, the picture ratio modes may be determined so as to be selected in an order of a normal screen mode, the screen fit mode, and the zoom fit mode. The normal screen mode is a 4:3 picture ratio mode.

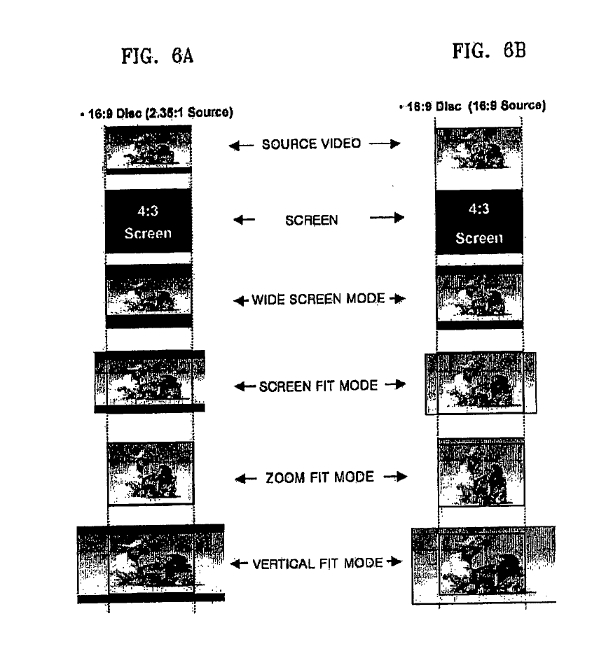

If the video signal recorded on the disc 111 has the picture ratio of 4:3 and the picture ratio set by the video display device 120 is 16:9, as shown in FIGS. 6A and 6B, the picture ratio modes may be determined so as to be selected in an order of the wide screen mode, the screen fit mode, the zoom fit mode, and the vertical fit mode. In the vertical fit mode, black bars appear in the right and left portions of a picture.

The above-mentioned picture ratio modes circulate when the user controls the picture ratio selection button 201′. For example, assuming that picture ratio modes are determined as shown in FIGS. 3A and 3B, when the picture ratio selection button 201′ is controlled after the zoom fit mode is selected, the zoom fit mode is changed into the letter box mode.

When information pieces of the available picture ratios of the video signal reproduced from the disc 111 are n and the information pieces of the picture ratios that can be supported by the video display device 120 are m, the memory 118 can divide information pieces of the selectable picture ratio modes into n×m groups and then stores the n×m groups. In other words, as described above with reference to FIG. 3A through FIG. 6B, the memory 118 may divide the picture ratio modes into four picture ratio mode groups to store information of the selectable picture ratio modes.

Accordingly, when the video signal recorded on the disc 111 has the picture ratio of 16:9 and the picture ratio that may be supported by the video display device 120 is 4:3, the system controller 115 reads the information including the picture ratio modes defined in FIGS. 3A and 3B from the memory 118 to determine the selectable picture ratio modes.

Whenever a signal to request the selection of the picture ratio is received via the remote control receiver 116 after the plurality of selectable picture ratio modes are determined as described above, the system controller 115 provides the decoder 117 with information of the picture ratio mode determined by the order of choosing the determined picture ratio modes.

The decoder 117 decodes the video signal to output the video signal having the picture ratio mode set by the system controller 116.

The remote control receiver 116 receives the signal transmitted from the remote control device 100 and then provides the system controller 115 with the signal.

The video display device 20 is a device such as a television.

In the aspect presented in FIG. 1, the selectable picture ratio modes are determined with reference to the picture ratio mode information grouped in the memory 118. Alternatively, the system controller 115 may determine the plurality of selectable picture ratio modes based on the information of the picture ratio of the video signal reproduced from the disc 111 and the picture ratio that can be supported by the video display device 120, among the plurality of picture ratio mode information.

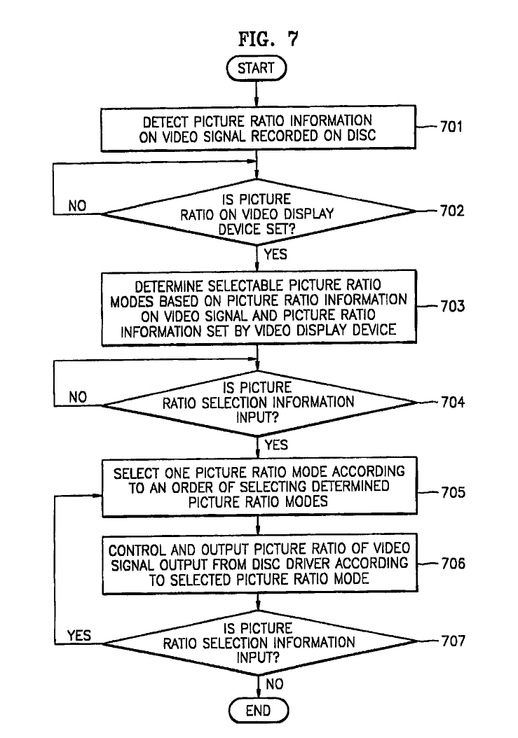

FIG. 7 is a flowchart of a picture ratio controlling method according to another aspect of the present invention. At operation 701, the system controller 115 detects the information of the picture ratio of the video signal recorded on the disc 111. As described with reference to FIG. 1, the picture ratio information is detected from the management information recorded on the disc 111.

At operation 702, the system controller 115 checks whether the picture ratio information of the video display device 120 is set. The picture ratio information of the video display device 120 is set according to TV mode information selected by the user using the setup menu as described above. If the system controller 112 determines that the picture ratio information of the video display device 120 is set, at operation 703, the system controller 115 determines a plurality of selectable picture ratio modes based on the picture ratio information detected in steps 701 and 702 as described in FIG. 1. As described with reference to FIG. 1, the system controller 115 may determine the plurality of picture ratio modes alone or with reference to the grouped picture ratio mode information stored in the memory 118.

At operation 704, the system controller 115 checks whether picture ratio selection information is received via the remote control receiver 116. If the system controller 115 determines that the picture ratio selection information is received via the remote control receiver 116, at operation 705, the system controller 115 selects one picture ratio mode among the plurality of selectable picture ratio modes and according to the order of the picture ratio modes determined at operation 703.

At operation 706, the system controller 115 controls the picture ratio of the video signal output from the disc drive 110 according to the selected picture ratio mode.

At operation 707, if the system controller 115 determines that the picture ratio selection information is received via the remote control receiver 116, the system controller 115 returns to operation 705 to select the picture ratio mode in a next position of the order of the determined picture ratio modes. However, at operation 707, if the system controller 115 determines that the picture ratio selection information is not received via the remote control receiver 116, the system controller 115 ends the picture ratio selection operation.

The above-described aspects of the present invention have been described by being limited to a hybrid system including the disc drive 110 and the video display device 120. However, the above-described aspects can also be applied to a case that when the video signal provided from another type of video signal providing apparatus and not from the disc drive 110 is displayed on the video display device 120 and the picture ratio of the video signal displayed on the video display device 120 can be controlled. In addition, the picture ratio of the video signal provided to the video display device 120 may be controlled. In this case, picture ratio selection information generated by the remote control device 100 is provided to the video display device 120.

As described above, according to an aspect of the present invention, by controlling a picture ratio of a video signal provided to a video display device, such as a television, according to a picture ratio mode selected by a user, the user can easily control the picture ratio displayed on the video display device.

In addition, unnecessary picture ratio selection is not performed by selecting a desired picture ratio mode, among a plurality of picture ratio modes, and determined in consideration of the picture ratio that is supported by the video display device and the picture ratio of a source video.

Moreover, the user can control the ratio of the picture displayed on a television by manipulating only the picture ratio selection key included in a remote control device or a disc drive (or a disc player) in a hybrid system including the disc drive and the television, so that the ratio of the picture displayed on the television is easily controlled.

Although a few aspects of the present invention have been shown and described, it would be appreciated by those skilled in the art that changes may be made in this aspect without departing from the principles and spirit of the invention, the scope of which is defined in the claims and their equivalents.

What is claimed is:

1. A picture ratio controlling apparatus, comprising:
a video display device displaying a video; and
a system controller determining a selectable picture ratio mode based on information of a picture ratio of a source video provided to the video display device and the information of the picture ratio that is supported by the video display device and controlling the picture ratio of the source video provided to the video display device when a user requests a picture ratio selection.

2. The picture ratio controlling apparatus of claim 1, further comprising:
a remote control receiver receiving the request for the picture ratio selection.

3. The picture ratio controlling apparatus of claim 2, wherein the remote control receiver further receives a signal to select the picture ratio information that is supported by the video display device.

4. The picture ratio controlling apparatus of claim 1, wherein if a plurality of selectable picture ratio modes are determined, the system controller determines an order to select the plurality of selectable picture ratio modes, and selects one picture ratio mode when the picture ratio selection is requested to control the picture ratio of the source video.

5. The picture ratio controlling apparatus of claim 1, further comprising:
a memory classifying the information of selectable picture ratio modes, which are determined based on the picture ratio information of the source video and the picture ratio information that is supported by the video display device into n×m groups, and storing the n×m groups if the information of available picture ratios of the source video are n and the information of the picture ratios that are supportable by the video display device are m,
wherein the system controller determines the picture ratio modes with reference to the information group of the selectable picture ratio modes read from the memory and based on the picture ratio information of the source video and the picture ratio information that is [supported] supportable by the video display device.

6. The picture ratio controlling apparatus of claim 2, wherein the remote control device selects a picture ratio selection command and the picture ratio information that are supported by the video display device.

7. The picture ratio controlling apparatus of claim 1, wherein the picture ratio information is set using a setup menu.

8. The picture ratio controlling apparatus of claim 4, further comprising:
a memory classifying the information of selectable picture ratio modes, wherein the system controller determines the plurality of picture ratio modes alone or with reference to the selectable picture ratio modes stored in the memory.

9. The picture ratio controlling apparatus of claim 6, wherein the remote control device comprises a setup button, an enter button, and direction buttons.

10. A remote control device to control a picture ratio of a video displayed on a video display device, the remote control device comprising:
a button unit comprising buttons and a picture ratio selection button to select the picture ratio of the video;
a memory storing code information corresponding to functions that are controlled using the buttons in the button unit;
a controller reading a corresponding code from the memory when the picture ratio selection button is controlled and transmitting the code to the video display device; and
a transmitter transmitting the code to the video display device.

11. A remote control device to control a picture ratio of a video displayed on a video display device in a hybrid system, wherein the hybrid system comprises a video signal proving unit providing a source video and the video display device displaying a video signal, the remote control device comprising:
a button unit comprising buttons and a picture ratio selection button to select the picture ratio of the source video output from the video signal providing unit;
a memory storing code information corresponding to functions that are controlled using the buttons in the button unit;
a controller reading a corresponding code from the memory when the picture ratio selection button is controlled and transmitting the code to the video signal providing unit; and
a transmitter transmitting the code to the video signal providing unit.

12. The remote control device of claim 11, wherein one of the buttons of the button unit selects picture ratio information supported by the video display device, and the controller provides the picture ratio information to the video signal providing unit.

13. A picture ratio controlling apparatus used in a system comprising a disc drive and a video display device, the picture ratio controlling apparatus comprising:
a digital signal processor converting a video signal picked up from a disc loaded into the disc drive into a digital signal;
a decoder decoding the digital signal output from the digital signal processor to provide the decoded video signal to the video display device; and
a system controller determining a selectable picture ratio mode based on picture ratio information of the decoded video signal and the picture ratio information that is supported by the video display device and controlling the decoder so that a picture ratio of the video signal output from the disc driver is controlled by a picture ratio mode selected when a user requests a picture ratio selection.

14. The picture ratio controlling apparatus of claim 13, wherein if a plurality of selectable picture ratio modes are determined, the system controller determines an order to select the plurality of selectable picture ratio modes, and selects one picture ratio mode when the picture ratio selection is requested to control the picture ratio of the video signal output from the disc drive.

15. The picture ratio controlling apparatus of claim 13, wherein the disc drive comprises:
a pickup unit picking up the video signal and outputting an RF signal indicative thereof, wherein the RF signal comprises management information comprising picture ration information of the disc,
a radio frequency (RF) amplifier amplifying the RF signal to a value, wherein the digital signal processor converts the amplified RF signal to the digital signal, and
a remote control receiver outputting a signal to request a selection of the picture ratio after the plurality of selectable picture ratio modes are determined, wherein the decoder decodes the video signal to output the video signal having the picture ratio mode set by the system controller.

16. The picture ratio controlling apparatus of claim 13, wherein when the picture ratio of the video signal reproduced from the disc is 16:9 and the picture ratio supported by the video display device is 4:3, the picture ratio modes are selected in an order of a letter box mode, a pan and scan mode, a screen fit mode, and a zoom fit mode.

17. The picture ratio controlling apparatus of claim 15, wherein the screen fit mode controls the picture ratio according to a line interpolation so that a picture to be displayed on the video display device stretches up and down.

18. The picture ratio controlling apparatus of claim 15, wherein the zoom fit mode adjusts right and left portions and upper and lower portions of a picture on the video display device so that the picture ratio of the picture is fit for the picture ratio supported by the video display device.

19. The picture ratio controlling apparatus of claim 13, wherein when a case where the video signal recorded on the disc has the picture ratio of 16:9 and the picture ratio set by the video display device is 16:9, the picture ratio modes are selected in an order of a wide screen mode, a screen fit mode, and a zoom fit mode.

20. The picture ratio controlling apparatus of claim 13, wherein if the video signal recorded on the disc has the picture ratio of 4:3 and the picture ratio set by the video display device is 16:9, the picture ratio modes are selected in an order of a wide screen mode, a screen fit mode, a zoom fit mode, and a vertical fit mode where black bars appear in right and left portions of a picture to be displayed on the video display device.

21. A method of controlling a ratio of a picture displayed on a video display device, the method comprising:
collecting picture ratio information of a video signal provided to the video display device and the picture ratio information that is supported by the video display device;
determining a selectable picture ratio mode based on the picture ratio information of the video signal and the picture ratio information that is supported by the video display device; and
controlling the ratio of the picture displayed on the video display device by controlling the picture ratio of the video signal to be fit for the picture ratio mode selected among the determined picture ratio modes when a user requests a picture ratio selection.

22. The method of claim 21, further comprising:
determining the selectable picture ratio mode by detecting a corresponding picture ratio mode group among a plurality of picture ratio mode groups pre-set in consideration on a number of picture ratio information of the video signal and the number of picture ratio information that is supported by the video display device.

23. The method of claim 21, wherein the picture ratio information of the video signal is collected using a result obtained by analyzing management information in the video signal, and the picture ratio information that is supported by the video display device is collected using information pre-set by the user.

24. A picture ratio controlling method used in a system comprising a disc drive and a video display device to display a video signal provided from the disc drive, the picture ratio controlling method comprising:
collecting picture ratio information of a video signal reproduced from a disc loaded into the disc drive and the picture ratio information that is supported by the video display device;
determining a selectable picture ratio mode based on the picture ratio information of the video signal reproduced from the disc and the picture ratio information that is supported by the video display device; and
controlling a ratio of a picture displayed on the video display device by controlling a picture ratio of the video signal reproduced from the disc to be fit for the picture ratio mode selected among the determined picture ratio modes when a user requests a picture ratio selection.
